(19) United States
(12) Patent Application Publication
(10) Pub. No.: US 2019/0359891 A1
(43) Pub. Date: Nov. 28, 2019

(54) PYROLYSIS SYSTEM FOR SOLVENTS, CARBON AND OTHER PYRO-PRODUCTS

(71) Applicant: Plus5, Inc., Windermere, FL (US)

(72) Inventors: Paul Andrade, Windermere, FL (US); Roger Anton Sramek, Mill Valley, CA (US)

(73) Assignee: Plus5, Inc., Windermere, FL (US)

(21) Appl. No.: 16/421,485

(22) Filed: May 24, 2019

Related U.S. Application Data
(60) Provisional application No. 62/676,888, filed on May 25, 2018.

(51) Int. Cl. C10B 53/07; C10B 7/14; C10B 27/06; C10B 41/00; B01D 5/00; B01D 53/00; B01D 53/18; B03C 1/30

(52) U.S. Cl. CPC C10B 53/07; C10B 7/14; C10B 27/06; B03C 1/30; B01D 5/0036; B01D 53/002; B01D 53/18; C10B 41/00

(57) ABSTRACT

The present invention is a pyrolysis system including a furnace for batch pyrolysis processing. The pyrolysis system receives scrap tires or other organic waste materials as inputs and performs batch pyrolysis processing to produce pyro-products as outputs. The pyro-products produced include pyro-vapors from which are condensed pyro-oil with a surviving pyro-gas and also include pyro-solids, particularly pyro-carbon (carbon char) and steel. The pyro-oil includes an inhibitor.

### BACKGROUND OF THE INVENTION

This invention relates to a pyrolysis system for processing scrap tires and other organic waste materials to recover pyrolysis-derived products including oil, carbon, gas and steel.

For many years, the question of how to best dispose of millions of scrap tires every year has produced different answers over time. One disposal method is to deposit scrap tires in landfills, open fields, behind buildings and other places. Research has shown that there is a significant environmental hazard resulting from disposing of massive numbers of scrap tires in landfills. Landfills for tires are undesirable because they become homes for diseases and present fire hazards. These hazards exist for a long time since it takes centuries to fully decompose scrap tires in landfills. Preferred methods of disposing of scrap tires have shifted away from landfills. The shift away from landfills is coupled with recognition that even though a scrap tire's useful life as a tire has ended, there still remains useful, recoverable and valuable materials within scrap tires.

Another disposal method uses scrap tires as fuel. The use as a fuel became popular for incineration of scrap tires at cement kilns, pulp plants, steam boilers and other similar places. In preparation for incineration, scrap tires are cleaned and then cut into small pieces that are added as a supplement to other fuels being combusted. The use of scrap tires as a fuel is known as “Tire Derived Fuel (TDF)” and still takes place today. However, social and governmental pressures to cut stack emissions has forced the users of scrap tire fuel to provide additional emission control equipment at rising costs. Although the US Environmental Protection Agency (EPA) has continued to accept the use of Tire Derived Fuel, the acceptance is mostly through grandfathered provisions. The search for better disposal methods for scrap tires continues in order to avoid the highly undesirable results of scrap tire incineration.

Another disposal method processes scrap tires to form crumb rubber. The crumb rubber process requires a relatively small capital investment and uses simple operating equipment, generally described as grinding, cutting and shredding equipment. The crumb rubber process does not change the chemical composition of a tire or its components, but only changes the mechanical shape and size of the tire material. Many crumb rubber applications using recycled scrap tire material have emerged and the value of the scrap tires for crumb rubber uses is generally greater than the value of the scrap tires for fuel uses. Like the use of scrap tires as a TDF, crumb rubber processors have come under scrutiny from the EPA. In early 2015, the EPA ceased endorsement of crumb rubber products as increased research and legal action proved a high level of human contact with the many forms of the product can lead to health complications.

Although crumb rubber uses are an improvement over landfill and fuel, the full potential of scrap tires still has not been achieved. The scrap tire constituent parts have higher potential value than the value that results from scrap tires for fuel or for crumb rubber. Many experiments have been undertaken seeking the best method of extracting value from scrap tires and the best method needs to be simple, environmentally acceptable and profitable.

Pyrolysis has been proposed as the best method for obtaining value from scrap tires. Pyrolysis is the application of high heat in oxygen-free environments. Tire pyrolysis processes has two forms, a “Continuous Pyrolysis Process” and a “Batch Pyrolysis Process”. Both the continuous and batch pyrolysis processes include at least the steps of loading whole tires or pieces of tires, heating the tires to extract pyro-vapor, cooling the remaining pyro-solids and unloading the pyro-solids. In the continuous pyrolysis process, the steps are all continuously performed moving the pieces of tires and pyro-solids produced with a conveyor, auger or other mover through a heating chamber and other stations. In the batch pyrolysis process, the steps are all performed during discrete separate periods where tires and pyro-solids produced are in a retort and are not moved by a conveyor during each of the discrete pyrolysis steps.

In the continuous pyrolysis process, scrap tires are first typically shredded to form shredded scrap material and the loading step constitutes moving a continuous input supply of scrap tire material into a pyrolysis heating chamber. As the moving supply of tire material travels into and through the heating chamber, the heating step occurs and the pyro-vapor is extracted leaving the pyro-solids to continue to move by the conveyor through the heating chamber to the cooling station where the cooling step occurs. The pyro-solids continue to move through the cooling station and the unloading step unloads a continuous output of pyro-solids.

To provide a continuous input supply of scrap tire material for the continuous pyrolysis process, scrap tires are cut into small tire pieces, for example two inches more or less on a side. The small tire pieces are pushed by an auger or other conveyor into the oxygen-free heat chamber for the heating step. The high heat in the heat chamber changes the molecular structure of the scrap tires or other organic material and drives off pyro-vapors from the moving tire material or other scrap pieces. The pyro-vapors are subsequently condensed into pyro-gas and pyro-oil products that are sold for revenue generation. The remaining pyro-solids are pushed from the heat chamber into the cooling station for the cooling step. Pyro-carbon char and steel are unloaded in the unloading step and these are also sold for revenue generation.

Although the continuous pyrolysis process appears promising, a number of problems exist which tend to make that process financially unattractive. The continuous pyrolysis process uses relatively low temperatures (compared to the batch pyrolysis process) and uses short run times through the high heat chamber. These conditions result in pyro-products from a continuous pyrolysis process that are of lower value than pyro-products from a batch pyrolysis process. The shorter run times at the lower temperature of the heat chamber (compared with those of the batch pyrolysis process) produces pyro-carbon with high surface volatile content which prevents that pyro-carbon from being marketed for high prices. Furthermore, in the continuous pyrolysis process, the tire pieces and subsequent carbon char are continuously mixed, by operation of the auger or other conveyor equipment, as they travel through the high heat chamber thereby introducing small particles of pyro-carbon and ash into the pyro-vapor. When that pyro-vapor is condensed to pyro-oil, the pyro-oil has pyro-carbon impurities rendering the pyro-oil less valuable. Furthermore, although airlocks are utilized in an attempt to maintain an oxygen-free environment, the airlocks inherently allow some air to leak into the heating chamber. The leaked air results in oxidation creating ash and hence lessens the value of the pyro-products produced by the continuous pyrolysis process. Where possible, nitrogen is introduced to purge or reduce, to the extent possible, the presence of oxygen in the heating chamber.

The cutting of the scrap tires into small pieces adds substantial costs to equipment, maintenance, labor and energy consumption for the continuous pyrolysis process. Also, as a consequence of cutting scrap tires into small pieces, the steel in scrap tires is also cut into small pieces. The process of fully removing small steel pieces is time consuming and must be done since purchasers do not want steel in the carbon. Additionally, the continuous processing equipment requires many moving parts that require high maintenance (such as blades requiring sharpening) and down time for maintenance. All of the above factors lead to higher costs for continuous pyrolysis operations relative to the selling price of the finished material. Because of these factors, continuous pyrolysis processes have struggled to be financially attractive.

In the batch pyrolysis process, each of the steps of loading the tires, heating the tires to extract pyro-vapor, cooling the pyro-solids and unloading the pyro-solids occurs for one retort at different time periods. During the loading period, typically whole scrap tires or large scrap tire pieces are loaded into a retort. After the loading period, the heating period occurs to heat the retort and pyro-vapor is removed leaving pyro-solids in the retort. After the heating period, the retort is cooled during the cooling period. During the heating and cooling periods, the scrap tires are not moved by an auger or other conveyor equipment and hence the introduction of pyro-carbon or ash into the pyro-vapor is minimized.

The batch pyrolysis process typically utilizes whole scrap tires (often baled) and uses large cut pieces of large tires. Since the scrap tires do not need to be cut into small pieces, the cost of cutting scrap tires is avoided or minimized and the cost of removal of steel from the pyro-carbon char is also minimized. Since the heating in the retort of batch pyrolysis process occurs at higher temperatures and for longer heat cycles than occurs in a continuous pyrolysis process, the batch pyrolysis process yields pyro-carbon with the highest amount of volatiles driven off as pyro-vapor. The pyro-carbon thus produced by the batch pyrolysis process is more valuable with an increased amount of applied uses. The batch pyrolysis process does not use tire or pyro-carbon moving devices, such as an auger, during the high heat processing time. Therefore, maintenance costs, down time and parts replacement are reduced for the batch pyrolysis process due to the absence or minimization of moving parts.

The batch pyrolysis process has a batch pyrolysis cycle having sequential processing steps occurring during discrete periods. The discrete periods include a loading period, a purging period, a heating period to drive off and remove pyro-vapor, a cooling period (purging is optional) and an unloading period. The discrete periods of operation for steps associated with a retort in the batch pyrolysis process are distinguished from the continuous processing steps in the continuous pyrolysis process.

Research has determined that the batch pyrolysis process produces higher value pyro-products than are produced by a continuous pyrolysis process and hence the batch pyrolysis process is a preferred method of obtaining value from scrap tires. Although continuous pyrolysis processes emphasize speed, inferior product are produced.

In consideration of the above background, there is a need for improved pyrolysis equipment and processes that take advantage of the higher value of the pyro-products from a batch pyrolysis process and which are scalable for high volume processing of scrap tires.

### SUMMARY

The present invention is a batch pyrolysis system including a furnace functioning as a retort for pyrolysis processing. The pyrolysis system receives scrap tires or other organic waste materials as inputs and performs pyrolysis processing to produce pyro-products as outputs. The pyro-products produced include pyro-vapors that are separated into non-condensable pyro-gas and condensed pyro-oil and include pyro-solids, particularly pyro-carbon (carbon char) and steel.

In one embodiment, the pyro-oils include solvents including inhibitors, having polar components and non-polar components. The inhibitors are particularly useful in dissolving or inhibiting the formation of waxes such as paraffin in down-well pump parts in oil wells, lines and other oil processing and transporting equipment. The inhibitors are also useful in lowering the viscosity of crude oil containing asphaltenes, thus increasing the flow rates and production volumes.

The pyrolysis system includes a load station for loading tires or other waste material into a transportable cart, a pyrolysis station for receiving the cart with the waste material and for pyrolysis processing of the waste material to remove pyro-gases and an unloading station for removing pyro-solids from the cart after pyrolysis processing. A cart transport moves the cart among the load station for the loading operation, the pyrolysis station for the pyrolysis operation and the unload station for the unload operation. When tires are bailed, the bailing process when desired is performed at remote locations such as tire collection or sorting sites thereby reducing the costs of loading, transporting and unloading tires.

In the pyrolysis furnace, a furnace door opens and closes for transporting the cart in and out of the furnace. The furnace provides a furnace chamber for receiving the cart holding the waste materiel. The furnace door seals the furnace during pyrolysis processing. The furnace includes a furnace exhaust port (vapor transport line) for transporting pyro-vapors from the sealed furnace resulting from the pyrolysis of the waste material. The chamber includes internal heat sources to heat the furnace chamber to pyrolysis temperatures (and to cool the chamber after pyrolysis) and thereby convert the waste materials to pyro-products. The internal heat sources are typically heated by an external heat unit. Typically the external heat unit generates the heat by combustion of fuels within a heat exchanger mechanism. After the pyrolysis cycle, the pyro-vapors from the pyrolysis of the waste material have been exhausted from the sealed furnace by way of the vapor transport line. After the pyrolysis processing including the cooling, the furnace door is opened and the cart with the pyro-solids is transported out of the furnace to the unload station. The unload station removes the pyro-solids for further processing. The pyrolysis system includes a vapor unit for receiving the pyro-gasses from the furnace and for condensing oil from the pyro-gasses and includes an oil unit for receiving the pyro-oil produced by the pyrolysis operation.

In one embodiment, a plurality of furnaces is configured as a unitary pyrolysis system wherein the batch pyrolysis operating cycles of the different furnaces are offset in time. With furnace cycles offset in time and by way of example, at any particular time, the processing for one furnace is at a load operation, the processing for another furnace at a pyrolysis operation and still another of the furnaces is at unload operation. While each of the particular furnaces operates with steps in discrete periods and hence each furnace is not continuous, the plurality of furnaces collectively taken together form a unitary pyrolysis system that tends to accept a substantially continuous input of scrap tires and tends to provide a continuous output of pyro-products.

In one embodiment, the unload station is in a separate room for removing and processing pyro-solids

In one embodiment, the vapor units include condenser units for cooling vapors such as the pyro-gases to separate pyro-liquids from uncondensed pyro-gases and includes an uncondensed gas unit connected for processing the uncondensed pyro-gases to provide gas products and to provide fuel.

In one embodiment, the resultant gas and/or oil generated by the pyrolysis process is used as a fuel source for the heat cycle of the furnaces.

In one embodiment, the condenser units operate over different temperature ranges to fractionally condense oils of different molecular weights and the system further includes a condensed liquid unit for processing the oils of different weights to form a variety of oil products.

In one embodiment, a control unit controls the furnaces over pyrolysis cycles, each pyrolysis cycle including a load step, a purge step, a temperature increase step, a temperature steady step, a temperature decrease step and an unload step.

In one embodiment for the pyrolysis cycles, the temperature increase step, the temperature steady step and the temperature decrease step are each about 3 hours long.

In one embodiment, the pyrolysis cycles for furnaces are offset in time whereby the pyrolysis system operates in a continuous mode.

In one embodiment, the pyrolysis cycles are offset in time where in one eight furnace embodiment, the offset is approximately 2 hours.

In one embodiment, the temperature steady step is at approximately 1800° F. whereby pyro-carbon produced is substantially free of surface volatiles.

In one embodiment, the furnaces have the same design and are interchangeable with other furnaces to facilitate maintenance and repairs in the system.

In one embodiment, a control unit turns off one or more of the furnaces while continuing operations with other furnaces whereby pyrolysis processing for the system continues with one or more of the furnaces off.

In one embodiment, a control unit matches the processing capabilities of furnaces to the waste material supply.

In one embodiment, a control unit sets the pyrolysis operational parameters for some furnaces different from the pyrolysis operational parameters for other furnaces.

In one embodiment, the waste material includes tires with large pieces of steel and the large pieces of steel are removed from the pyro-solids leaving pyro-carbon char not requiring extensive processing for steel removal.

In one embodiment, a fan or fans is/are included within a furnace for circulating gases within the sealed furnace to distribute heating within the furnace for even heat distribution. Also, the fans are used for circulating nitrogen during the purge step or during the cooling stage.

The foregoing and other objects, features and advantages of the invention will be apparent from the following detailed description in conjunction with the drawings.

### BRIEF DESCRIPTION OF THE DRAWINGS

FIG. 1 depicts a pyrolysis system having a load station, a pyrolysis station and an unload station with transportable carts that move among the stations.

FIG. 2 depicts a schematic view of an alternate furnace for the pyrolysis system of FIG. 1.

FIG. 3 depicts a top view of a stack of tires of one size bailed together.

FIG. 4 depicts a front view of the stack of tires of FIG. 3.

FIG. 5 depicts a top view of another stack of tires of the FIG. 3 size bailed together.

FIG. 6 depicts a front view of the stack of tires of FIG. 5.

FIG. 7 depicts a top view of another stack of tires of the FIG. 3 size bailed together.

FIG. 8 depicts a front view of the stack of tires of FIG. 7.

FIG. 9 depicts a top view of another stack of tires of the FIG. 3 size bailed together.

FIG. 10 depicts a front view of the stack of tires of FIG. 9.

FIG. 11 depicts a front view of the tires of FIG. 4, FIG. 6, FIG. 8 and FIG. 10 stacked together.

FIG. 12 depicts a front view of the stacks of tires of FIG. 11 bailed together for insertion into a furnace.

FIG. 13 depicts a top view of a rectangular stack of tires compressed together for insertion into a furnace.

FIG. 14 depicts a side view of the rectangular stack of tires of FIG. 13.

FIG. 15 depicts a side view of the rectangular stack of tires of FIG. 13.

FIG. 16 depicts a front view of the rectangular stack of tires of FIG. 13 loaded in a cart for insertion into a furnace.

FIG. 17 depicts a front view of a stack of tire pieces cut from large tires and compressed together in a cart for insertion into a furnace.

FIG. 18 depicts a top view of the stack of tire pieces in the cart of FIG. 17.

FIG. 19 depicts a top view of an extra-large tire.

FIG. 20 depicts a top view of the tire of FIG. 19 cut in quarters.

FIG. 21 depicts a top view of the one-quarter section of the tire cut as shown in FIG. 20.

FIG. 22 depicts a front view of the one-quarter section of the tire section of FIG. 21.

FIG. 23 depicts a front view of a stack of tires of the FIG. 22 type.

FIG. 24 depicts a top view of tire sections of the FIG. 21 nested together.

FIG. 25 depicts a schematic perspective view of a cart used for transporting material among the load station, the pyrolysis station and the unload station.

FIG. 26 depicts a schematic cutaway view of a furnace with a stack of tires in a cart ready for pyrolysis processing.

FIG. 27 depicts a sequence of processing through a pyrolysis process.

FIG. 28 depicts a schematic view of a detailed vapor unit for use in the FIG. 1 system.

FIG. 29 depicts a typical graph of one example of the temperature of a furnace 2 during pyrolysis processing.

FIG. 30 depicts a pyrolysis system having a plurality of pyrolysis furnaces for receiving the transportable carts.

FIG. 31 depicts a schematic view of a pyrolysis system having groups of pyrolysis furnaces sharing vapor units.

FIG. 32 depicts a graph of one example of a typical temperature of a furnace cycled twice over a 24 hour period.

FIG. 33 depicts a graph of one example of typical temperatures of six furnaces cycled sequentially.

FIG. 34 depicts a graph of one example of typical temperatures often furnaces cycled sequentially.

FIG. 35 depicts a production well for pumping crude oil from the ground together with inhibitor apparatus for injecting an inhibitor into the production well.

FIG. 36 depicts a block representation of an inhibitor including polar and non-polar components.

### DETAILED DESCRIPTION

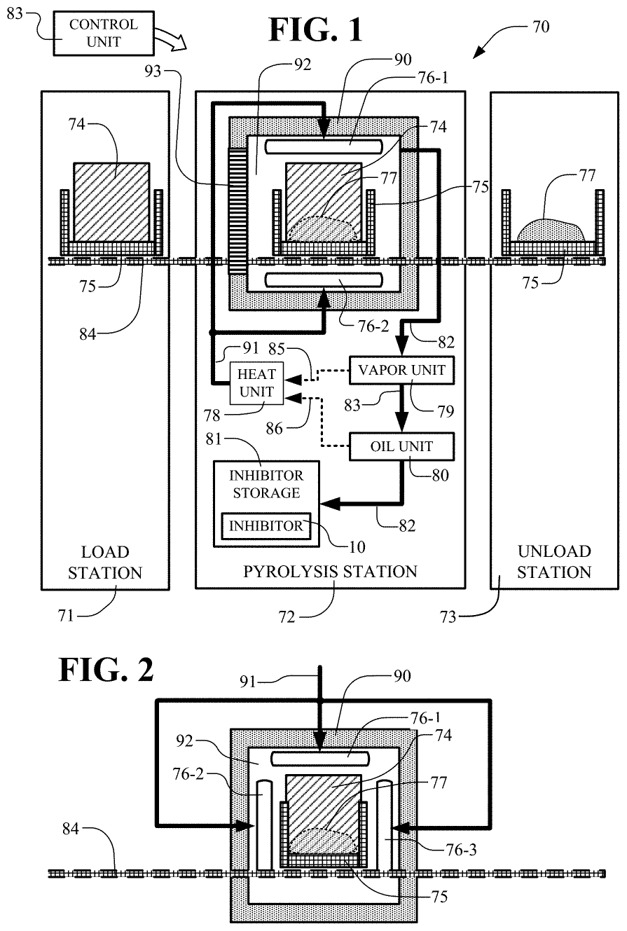

In FIG. 1, a pyrolysis apparatus 70 is shown. The pyrolysis system receives scrap tires 74 or other organic waste materials as inputs and performs pyrolysis processing to produce pyro-products as outputs. The pyro-products produced include pyro-vapors that are separated into pyro-oil and pyro-gas and include pyro-solids, particularly pyro-carbon (carbon char) and steel. One of the pyro-products is an inhibitor 10. The pyrolytic system 70 has a load station 71, a pyrolysis station 72, an unload station 73 and a control unit 83. The pyrolysis apparatus 70 includes a transportable cart 75 for moving along a transport track 84 or along other transport paths. The transport track 84 extends to each of the load station 71, the pyrolysis station 72 and the unload station 73. In the load station 71 scrap tires 74 or other materials for pyrolysis are loaded onto transportable cart 75 for transport along the track 84 to the pyrolysis station 72.

The pyrolysis station 72 has a pyrolysis furnace 90 for receiving the transportable cart 75 and the scrap tires 74. The furnace 90 includes a heat unit 78 for heating the furnace 90 to pyrolysis temperatures. The heat unit 78 connects via heat line 91 to heaters 76-1 and 76-2 within the furnace 90 where they operate to heat the pyrolysis chamber 92 to the pyrolysis temperatures. The heat unit 78 is supplied with fuel by different means. For example, the heat unit 78 receives fuel from a natural gas source (not shown), receives co-generated fuel from the vapor unit 79 on line 85, or receives co-generated fuel from the oil unit 80 on line 86. The choice of what fuel source is used for the heat unit 78 is a function of the cost, cleanliness and sufficiency of the fuel. Gas, oil or both may be used.

Before the pyrolysis operation, the scrap tires 74 or other materials are on the transportable cart 75. After pyrolysis, the pyro-solids 77 remain on the transportable cart 75 and are transported to the unload station 73. The entry and exit of the transportable cart 75 into and from the chamber 92 of furnace 90 is through a door 93 in the wall of the furnace 93. The door 93 is opened to receive the transportable cart 75 from the load station 71, is closed during the pyrolysis operation and thereafter is opened to allow transport of the cart 75 and pyro-solids 77 to the unload station 73.

The pyrolysis station 72 includes a vapor unit 79 that connects via the piping 82 to the furnace 90 to receive the vapors resulting from the pyrolysis operation. The vapor unit 79 connects by piping 83 to the oil unit 80. The oil unit 80 connects by piping 82 to the inhibitor storage 81 which stores the inhibitor 10 produced by the pyrolysis operation.

In FIG. 2, a schematic view of an alternate furnace 90 is shown for the pyrolysis system of FIG. 1. In FIG. 2, the heaters 76-1, 76-2 and 76-3 are positioned on the sides and top of the furnace 90. The cart 75 with the scrap tires 74, before pyrolysis, is positioned so as to be surrounded by the heaters 76-1, 76-2 and 76-3. After pyrolysis, the pyro-solids 77 remain in a pile on the cart 75 ready to be moved to an unload station.

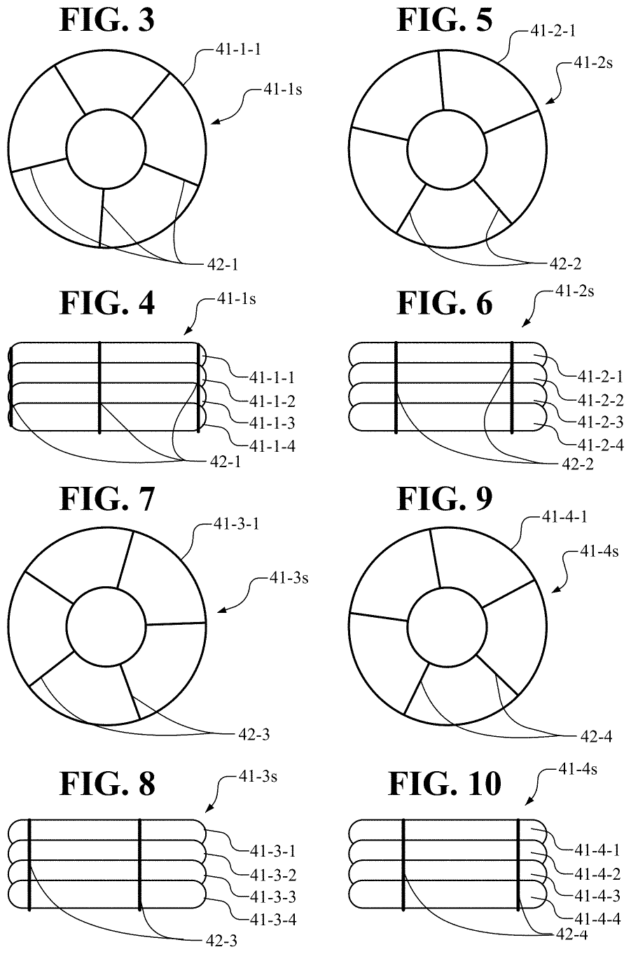

In FIG. 3, a top view is shown of a stack of tires 41-1s of one size, including a top tire 41-1-1, bailed together by bailing wires 42-1.

In FIG. 4, a front view is shown of the stack of tires 41-1s of FIG. 3. The stack 41-1s includes the four tires 41-1-1, 41-1-2, 41-1-3 and 41-1-4 bailed together by bailing wires 42-1.

In FIG. 5, a top view is shown of a stack of tires 41-2s of one size, including a top tire 41-2-1, bailed together by bailing wires 42-2 for insertion into a furnace.

In FIG. 6, a front view is shown of the stack of tires 41-2s of FIG. 5. The stack 41-2s includes the four tires 41-2-1, 41-2-2, 41-2-3 and 41-2-4 bailed together by bailing wires 42-2.

In FIG. 7, a top view is shown of a stack of tires 41-3s of one size, including a top tire 41-3-1, bailed together by bailing wires 42-3 for insertion into a furnace. The bailing wires are steel with magnetic properties that are easily removed magnetically from the char after processing.

In FIG. 8, a front view is shown of the stack of tires 41-3s of FIG. 7. The stack 41-3s includes the four tires 41-3-1, 41-3-2, 41-3-3 and 41-3-4 bailed together by bailing wires 42-3.

In FIG. 9, a top view is shown of a stack of tires 41-4s of one size, including a top tire 41-4-1, bailed together by bailing wires 42-4 for insertion into a furnace.

In FIG. 10, a front view is shown of the stack of tires 41-4s of FIG. 9. The stack 41-4s includes the four tires 41-4-1, 41-4-2, 41-4-3 and 41-4-4 bailed together by bailing wires 42-4.

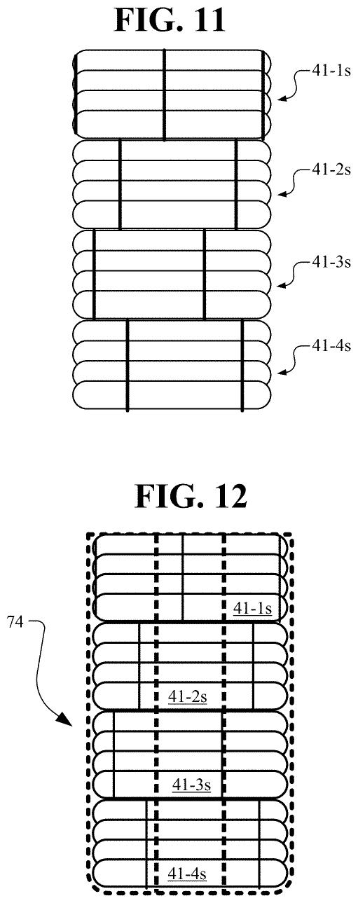

In FIG. 11, a front view is shown of the bailed tire stacks 41-1s, 41-2s, 41-3s and 41-4s of FIG. 4, FIG. 6, FIG. 8 and FIG. 10 which are stacked together for insertion into a furnace.

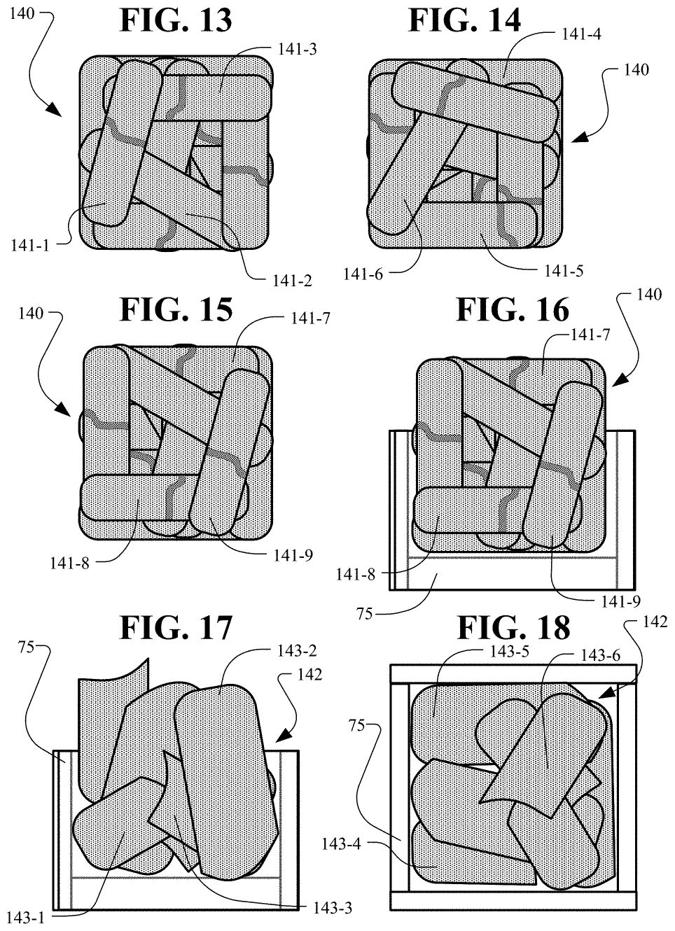

In FIG. 12, a front view is shown of the bailed tire stacks 41-1s, 41-2s, 41-3s and 41-4s of FIG. 11 bailed together as a stack 74.

In FIG. 13, a top view of a rectangular stack 140 of tires is shown. The stack 140 includes tires 141-1, 141-2, 143-3 and so on.

In FIG. 14, the side view of the rectangular stack 140 of tires of FIG. 13 is shown. The stack 140 includes tires 141-4, 141-5, 143-6 and so on.

In FIG. 15, a side view of the rectangular stack 140 of tires of FIG. 13 is shown. The stack 140 includes tires 141-7, 141-8, 143-9 and so on.

In FIG. 16, a front view of the rectangular stack 140 of tires of FIG. 15 is shown loaded in a cart 75 for insertion into a furnace. The stack 140 includes tires 141-7, 141-8, 143-9 and so on.

In FIG. 17, a front view of a stack 142 of tire pieces cut from large tires and compressed together in a cart 75 is shown ready for insertion into a furnace. The stack 142 includes tires 143-1, 143-2, 143-3 and so on.

In FIG. 18, a top view of the stack 142 of tire pieces in the cart 75 of FIG. 17 is shown. The stack 142 includes tires 143-4, 143-5, 143-6 and so on.

Tires can be of many different sizes. In the case of some large tires, for example large mining truck tires, the tires have thick steel bands that are difficult to cut. Such tires, in one embodiment, are “bagel” cut to remove the steel bands before cutting the tires into smaller pieces. In addition to the steel bands, the large tires have additional steel pieces in the tread and sidewalls that are readily cut along with the tire to fit the tire pieces into the cart for pyrolysis processing.

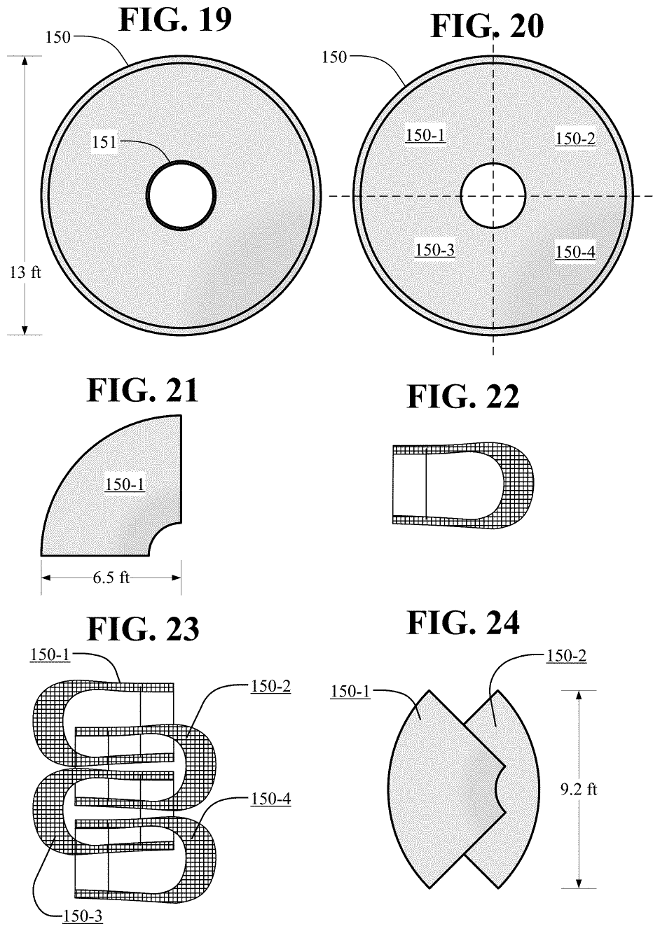

In FIG. 19, a top view of an extra-large tire 150 is shown. By way of example, tire 150 is thirteen feet in diameter with a center hole of three feet. Typically, such large tires have steel bands 151 removed by bagel cutting prior to cutting the tires into pieces

In FIG. 20, a top view of the tire 150 of FIG. 19, with steel bands removed, cut in quarters 150-1, 150-2, 150-3 and 150-4.

In FIG. 21, a top view of the quarter 150-1 of the tire 150 of FIG. 20 is shown.

In FIG. 22, a front view of the quarter 150-1 of FIG. 21 is shown.

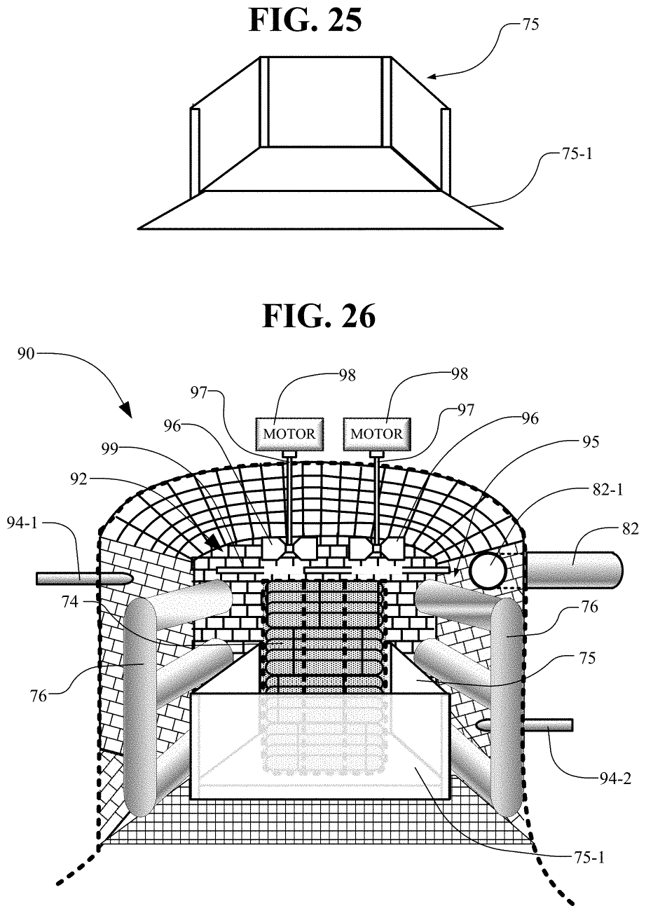

In FIG. 23, a front view of the four quarters 150-1, 150-2, 150-3 and 150-4 stacked for loading into a cart of the FIG. 25 type.

In FIG. 24, a top view of tire quarters 150-1 and 150-2 nested together for loading into a cart of the FIG. 25 type.

In FIG. 25, a schematic perspective view of a cart 75 is shown. The cart 75 is used for transporting material among the load station 71, the pyrolysis station 72 and the unload station 73 of FIG. 1. The cart 75 typically includes one side 75-1 shown open, in a hinged down position for example, for loading tires or other organic material for pyrolysis processing and for unloading pyro-solids after pyrolysis processing.

In FIG. 26, a schematic cutaway view of a furnace 90 is shown. The furnace 90 includes heaters 76 which are heated by heat unit 78 of FIG. 1 to pyrolysis temperatures. A stack of tires 74 are on cart 75 ready for pyrolysis processing in the furnace chamber 92. A vent 82-1 (vapor transfer line) is in the furnace wall 95 leading to the vent pipe 82 is shown for exhausting pyro-vapor from the chamber 92. A vent 94-1 and a vent 94-2 are provided for injecting nitrogen gas into the chamber 92 for purging oxygen (or air containing oxygen) through the port 82-1 and the pipe 82. The furnace 90 includes one or more fans 96 for circulating gases in the chamber 92. One or more fan shafts 97 extend from outside the furnace 90 from one or more motors 98 through the furnace wall to the fans 96. The motors 98 rotate the fans 96 which are positioned over baffles 99 that help direct the gases in the chamber 92. The fans are controlled in speed and have circulating gases directed to keep the gases from stirring up carbon or directing carbon into the vapor transfer line.

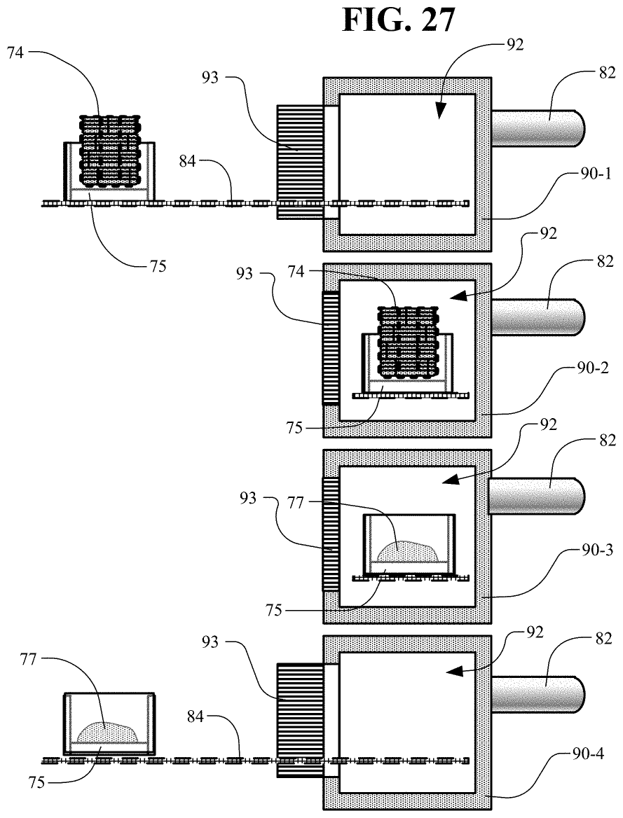

In FIG. 27, a sequence of pyrolysis processing is shown for a furnace 90 in four stages 90-1, 90-2, 90-3 and 90-4. In the first stage 90-1, the door 93 is open ready to receive the cart 75 and stack of tires 74. The cart 75 is ready to be transported along track 84 into the chamber 92. In the second stage 90-2, the door 93 is closed with the cart 75 and stack of tires 74 in the chamber 92. In the second stage 90-2, the pyrolysis processing occurs with an increase in temperature to pyrolysis levels. In the third stage 90-3, the pyrolysis processing continues with a decrease in temperature to leave a solid residue 77, the gas and oil pyro-products having been excavated from chamber 92. In the fourth stage 90-4, the pyrolysis processing is completed, the door 93 is opened and the cart 75 and the residue 77 is removed from the chamber 92.

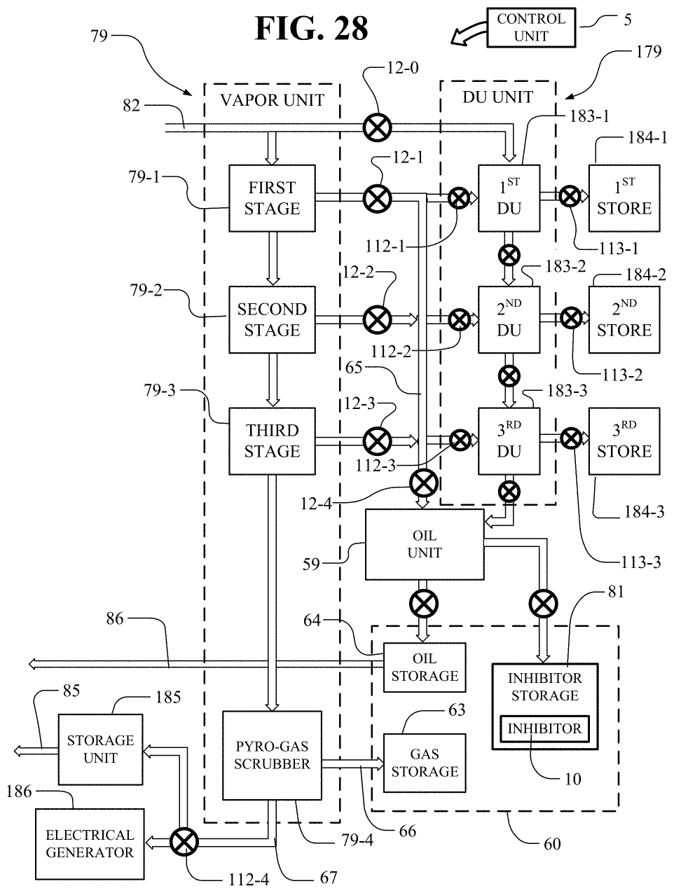

In FIG. 28, a schematic view of a detailed vapor unit 79 and distillation unit 179 are shown for use in the FIG. 1 system and with the furnace 90 of FIG. 26. The pyro-vapors produced during the pyrolysis processing are vented through the vapor transfer line including port 82-1 and pipe 82 of the FIG. 26 furnace to the vapor unit 79 and/or to the distillation unit 179. The vapor unit 79 includes, for example, condensing stages 79-1, 79-2 and 79-3 for processing the pyro-vapors to extract pyro-products including pyro-gases and pyro-oils. The first stage 79-1 is connected through valves 12-1, 12-4 and 112-1 which are opened or closed, under control of control unit 5, to extract pyro-oil or pyro-gas of a first property as pyro-oil or pyro-gas output products. The first stage 79-1 is connected through valves 12-1 and 112-1 which are opened or closed, under control of control unit 5, to extract pyro-gases for further processing in a fractional distillation unit (1^{st} DU) 183-1. The unit 183-1 connects through valve 113-1 to a 1^{st} storage unit 184-1 (1^{st} STORE).

The second stage 79-2 receives the output from the first stage 79-1 and is connected through valves 12-2, 12-4 and 112-2 which are opened or closed, under control of control unit 5, to extract pyro-oil or pyro-gas of a second property as pyro-oil or pyro-gas output products. The second stage 79-2 is connected through valves 12-2 and 112-2 which are opened or closed, under control of control unit 5, to extract pyro-gases for further processing in a fractional distillation unit (2^{nd} DU) 183-2. The unit 183-2 connects through valve 113-2 to a 2^{nd} storage unit 184-2 (2^{nd} STORE).

The third stage 79-3 receives the output from the second stage 79-2 and is connected through valves 12-3, 12-4 and 112-3 which are opened or closed, under control of control unit 5, to extract pyro-oil or pyro-gas of a first property as pyro-oil or pyro-gas output products. The third stage 79-3 is connected through valves 12-3 and 112-3 which are opened or closed, under control of control unit 5, to extract pyro-gases for further processing in a fractional distillation unit (3^{rd} DU) 183-3. The unit 183-3 connects through valve 113-3 to a 3^{rd} storage unit 184-3 (3^{rd} STORE).

The unit 183-1 receives an input from the vapor transfer line (pipe 82) under control of control unit 5. The unit 183-1, unit 183-2 and the unit 183-3 are connected in series through valves under control of control unit 5. The third unit 183-3 connects through a valve, under control of control unit 5, to the oil unit 59.

In vapor unit 79, the first stage 79-1, second stage 79-2 and third stage 79-3 are condenser units that operate over different temperature ranges to condense pyro-vapors from vapor transfer line pipe 82 of different molecular weights. The pyro-vapors of different molecular weights produce pyro-oils of different molecular weights, including inhibitors, through the valves 12-1, 12-2 and 12-3. The non-condensed pyro-gases not transferred to the fractional distillation unit 182 pass from the third stage 79-3 to the pyro-gas scrubber 79-4. The outputs from the valves 12-1, 12-2 and 12-3 on line 65 connect through valve 12-4 to the oil unit 59. The outputs from the oil unit 59 are stored in oil storage unit 64. The storage 64 typically includes different tanks for the different types of pyro-oil extracted by the different stages 79-1, 79-2 and 79-3 and includes the inhibitor storage 81 for storing inhibitor 10.

In distillation unit 179, the first stage 183-1, second stage 183-2 and third stage 183-3 are typically fractional distillation units that operate over different temperature ranges and augment the operation of the vapor unit 79 to condense pyro-vapors from vapor transfer line pipe 82 of different molecular weights. The pyro-vapors of different molecular weights produce pyro-oils and pyro-gases of different molecular weights that are stored in stores 184-1, 184-2 and 184-3. The non-condensed pyro-gases not stored are transferred to the oil unit 59. The pyro-gas output from the third stage 79-3 of the vapor unit 79 is input to the pyro-gas scrubber 79-4 which scrubs sulfur and other impurities from the pyro-gas to provide outputs on pipe 67 to provide pyro-gas products. One of the pyro-gas products from scrubber 79-4 on line 67 connects in FIG. 1 to line 86 to provide fuel to the heat unit 78. The pyro-gas scrubber 79-4 transports the pyro-gas via gas line 66 for storage in gas storage 63. The gas storage 63, the oil storage 64 and the inhibitor 81 comprise the product storage 60. The output from the pyro-gas scrubber 79-4 that is not a pyro-gas product is used as a fuel available on line 67 or is disposed of, by burning or other means. Line 67 connects to valve 112-4 that the fuel on line 67 to storage unit 185 and electrical generator 186. The storage unit 185 has an output line 85 that feeds the heat unit 78 of FIG. 1. Any sulfur is collected as a sulfur product.

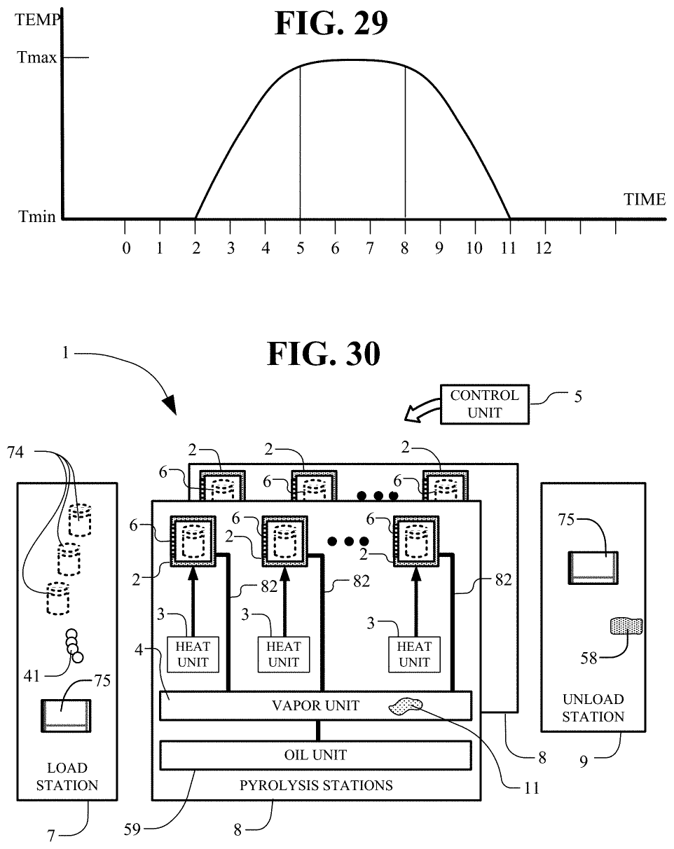

In FIG. 29, a graph is shown of the temperature of a furnace 90 of FIG. 1 during pyrolysis processing. The control unit 83 of FIG. 1 allows for tires to be bailed and ready to be loaded into a furnace 90 during a LOAD period. The cart is then loaded into the furnace 90 and is ready for pyrolysis processing. The furnace door is closed thereby forming the furnace chamber into a retort. Next, nitrogen gas is injected into the furnace to purge the chamber and force oxygen out. The control 83 causes the heat unit 78 to provide heat to the chamber 92 and the temperature begins to rise during the INCREASE period as indicated in FIG. 29 at the t2 hour. Initially, the temperature is at Tmin, for example, standard room temperature. The control unit 83 typically applies maximum heating over the INCREASE period causing the temperature to rise until the temperature approaches Tmax, for example 1800° F., at time t5 hour. The control unit 83 maintains the temperature at about Tmax during the STEADY period for about 3 hours until about t8 hour. Thereafter the heat is turned off. A DECREASE period of approximately 3 hours allows cooling to occur from about t8 hour until about t11 hour. The cooling can be accelerated by introducing cooling nitrogen into the furnace chamber 92 until the furnace chamber 92 approaches Tmin. After t11 hour, the control unit 83 of FIG. 1 allows for the pyro-solids to be unloaded during the UNLOAD period from t11 to t12 or longer if needed. Air is not introduced into the furnace 90 or chamber 92 while the temperature of any of the carbon residue 77 is over approximately 300 degrees F., otherwise the carbon can catch fire/oxidize when contact with oxygen is made. To avoid introducing oxygen into the chamber 92, a nitrogen gas, in one example, is used as a cooling substance. Also, a fan with a slow revolution setting is used to circulate the nitrogen and is operated so as not to stir up carbon dust. An alternative for cooling uses cool gas from the gas storage 63 where the pyro-gas is injected back into the furnace chamber 92.

Using the batch processing techniques as described and in one embodiment, the cooling is accelerated by introducing cooling gas (free of oxygen) into the furnace chamber 92 to reduce the temperature to less than 300 degrees F.

Using the processing techniques as described, the 1800° F. Tmax temperature is effective in driving off volatile substances such as contained in pyro-gases and pyro-oils so that the remaining pyro-carbon after pyrolysis processing has a very low surface volatile content.

Using the processing techniques as described, the sealed configuration of the furnace chamber 92 with oxygen purged from the furnace chamber 92 reduces or eliminates the burning/oxidation of the pyro-carbon product and eliminates creation of unnecessary ash content.

In FIG. 30, a unitary pyrolysis system 1 is shown having a plurality of pyrolysis furnaces 6, like the furnace 90 of FIG. 1, for receiving the transportable carts 75. Each of the furnaces 6 includes, in one embodiment, a heat unit 3, like heat unit 78 in FIG. 1, for heating the corresponding furnace 6. The pyrolysis stations 8, like the pyrolysis station 72 of FIG. 1, include a vapor unit 4, like the vapor unit 79 of FIG. 1, which connects on pipes 82 to each of the furnaces 6 and is shared by the furnaces 6. In addition, the unitary pyrolytic system 1 includes a load station 7 and an unload station 9 like the load station 71 and the unload station 73 of FIG. 1. The unitary pyrolytic system 1 receives scrap tires 41 as inputs and performs batch pyrolysis processing to produce pyro-products as outputs. The pyro-products produced include pyro-vapors 11 that are condensed into pyro-oil leaving some pyro-gas and pyro-solids 58, particularly pyro-carbon.

In the unitary pyrolysis system 1, the furnaces 6 are serviced by transportable carts 75. The carts 75 load scrap tires 41 in stacks 74 into the furnaces 6 for pyrolysis processing. The pyrolysis processing of the furnaces 6 engages the vapor unit 4 for injecting and exhausting vapors into and out from furnaces 6 in connection with pyrolysis processing. The carts 75 are then transported to the unload station 9. Pyro-vapors out from the furnaces 6 are condensed in vapor unit 4 to form pyro-gas and pyro-oil products that are further processed by pyro-oil unit 59 and stored in oil storage 64 and inhibitor storage 10. Vapors remaining from the furnace 6 after condensing are processed and stored as gas products and are processed, in some embodiments, to provide fuel for the heat units 3 of FIG. 1 or for cogeneration of electricity. Typically 70% to 80% is used for electrical generation. In the pyrolysis system 1, a solid unload station 9 is for removing pyro-solids 58 from the furnace 6 after gas and oil processing has occurred.

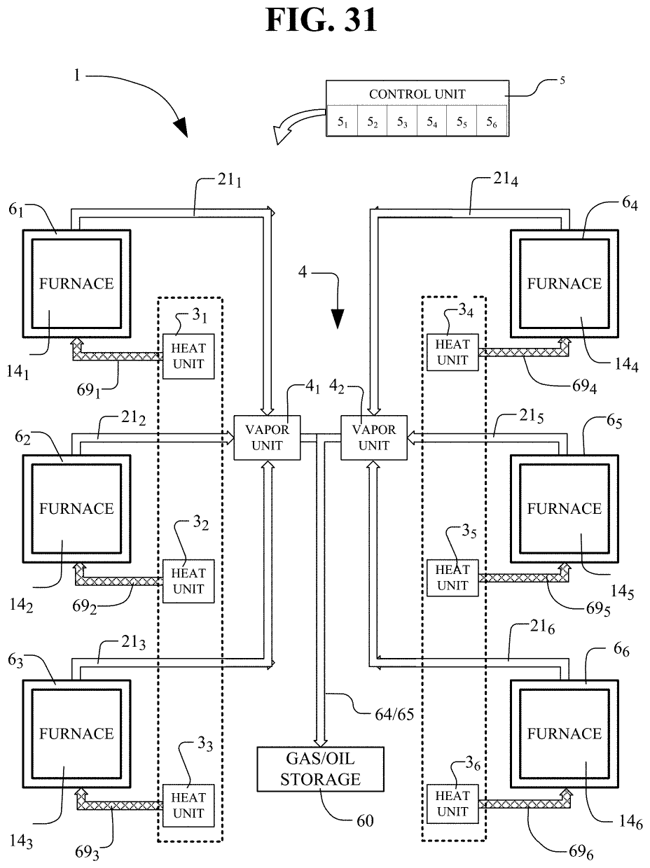

In FIG. 31, a schematic view of a pyrolysis system 1 is shown having groups of pyrolysis furnaces 6 sharing vapor units 4. Each furnace 6 performs a batch pyrolysis process. The plurality of furnaces 6 are configured as a unitary pyrolytic system 1 wherein the batch pyrolysis operating cycles of the different furnaces 6 are offset in time. With cycles offset in time and by way of example, at any particular time, operations for one or more furnaces 6 is in a loading period, one or more other furnaces 6 are in the pyrolysis period and still one or more furnaces 6 are in unloading periods. While each of the particular furnaces 6 operates with steps in discrete periods and hence each furnace 6 is not continuous, the plurality of furnaces 6 collectively taken together form a unitary pyrolytic system 1 that accepts input of scrap tires 41 that is a continuous input supply and provides an output of pyro-products, including pyro-vapor 11 and pyro-solids 58, that is a continuous output.

In FIG. 31, the unitary pyrolytic system 1 includes a first group of furnaces 6₁, 6₂, and 6₃ and a second group of furnaces 6₄, 6₅, and 6₆. The first group of furnaces 6₁, 6₂, and 6₃ connect to the vapor unit 4₁ and the second group of furnaces 6₄, 6₅, and 6₆ connect to the vapor unit 4₂. The first group of furnaces 6₁, 6₂, and 6₃ have heat units 3₁, 3₂, and 3₃, for heating the chambers 14₁, 14₂, and 14₃ through lines 69₁, 69₂, and 69₃. The second group of furnaces 6₄, 6₅, and 6₆ have heat units 3₄, 3₅, and 3₆, respectively, for heating the chambers the chambers 14₄, 14₅, and 14₆ through lines 69₄, 69₅, and 69₆.

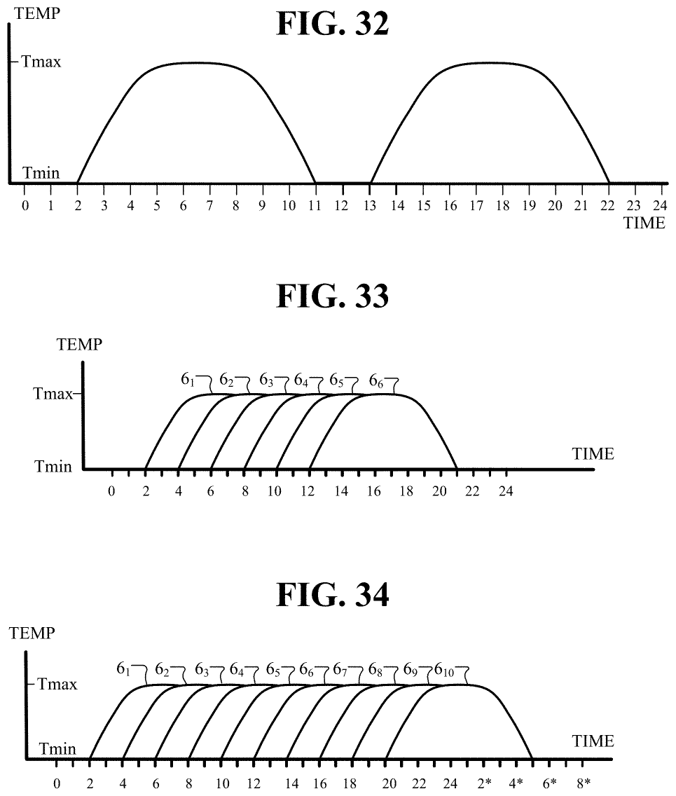

In FIG. 32, a graph of the temperatures of a furnace 6 cycled twice over a 24 hour period is shown. The control unit 5 of FIG. 30 allows for tires to be bailed and ready to be loaded into a furnace 6 during LOAD periods, t0-t2 and t11-t13. The control unit 5 causes the heat units 3 to provide heat to the chambers and the temperatures begin to rise during the INCREASE periods t2-t5 and t13-t16. Initially, the temperature is at Tmin, for example, standard room temperature. The control unit 5 typically applies maximum heating over the INCREASE period causing the temperature to rise until the temperature approaches Tmax, for example 1800° F., at time t5 and t16 hours. The control unit 5 maintains the temperature at about Tmax during the STEADY period for about 3 hours until about t8 and t19 hours. Thereafter the heat is turned off. A DECEASE period of approximately 3 hours allows cooling to occur from about t8-t11 and t19-t22 hours. The cooling can be accelerated by introducing cooling air into the furnace chamber until the furnace chamber approaches Tmin. After t11 and t22 hours, the control unit 5 allows for the pyro-solids to be unloaded during the UNLOAD period from t11-t13 and t22-t24.

In FIG. 33, a graph is shown of the temperatures of six furnaces cycled sequentially. The graphs of the temperatures of six furnaces 6 of FIG. 33 are shown over approximately a one day 24 hour period. The six furnaces are 6₁, 6₆, 6₃, 6₄, 6₅, and 6₆. These six furnaces are connected to the vapor unit 4-1 of FIG. 31. The LOAD, INCREASE, STEADY, DECREASE and UNLOAD periods for the six furnaces 6₁, 6₆, 6₃, 6₄, 6₅, and 6₆ are listed in the TABLE 1.

TABLE 1

| | LOAD | INCREASE | STEADY | DECREASE | UNLOAD |
|---|---|---|---|---|---|
| 6₁ | t0-t2 | t2-t5 | t5-t8 | t8-t11 | t11-t13 |
| 6₂ | t2-t4 | t4-t7 | t7-t10 | t10-t13 | t13-t15 |
| 6₃ | t4-t6 | t6-t9 | t9-t12 | t12-t15 | t15-t17 |
| 6₄ | t6-t8 | t8-t11 | t11-t14 | t14-t17 | t17-t19 |
| 6₅ | t8-t10 | t10-t13 | t13-t16 | t16-t19 | t19-t21 |
| 6₆ | t10-t12 | t12-t15 | t15-t18 | t18-t21 | t21-t23 |

As is evident from TABLE 1, the offset of the processing steps for each of the furnaces 6₁, 6₂, 6₃, 6₄, 6₅, and 6₆ distributes the use of the system facilities so that no facility presents a bottleneck for processing. For example, each of the furnaces 6 is allocated a different time for the LOAD step so that loading is evenly distributed at the load station 7. Similarly, each of the furnaces 6 is allocated a different time for the UNLOAD step so that unloading is evenly distributed at the unload station 9. The pyrolysis processing during the INCREASE, STEADY and DECREASE steps balances the load on the vapor unit 4-1.

Similar to the example described in connection with FIG. 33 and TALE 1, the four furnaces 6₇, 6₈, 6₉, and 6₁₀ are operated as a separate unit with, in one example, the furnaces 6₁, 6₂, 6₃, 6₄, 6₅, and 6₆ idle. These four furnaces 6₇, 6₈, 6₉, and 6₁₀ are connected to the vapor unit 4-2 of FIG. 31. The LOAD, INCREASE, STEADY, DECREASE and UNLOAD steps for the four furnaces 6₇, 6₈, 6₉, and 6₁₀ are analogous to those periods in TABLE 1 using two fewer furnaces.

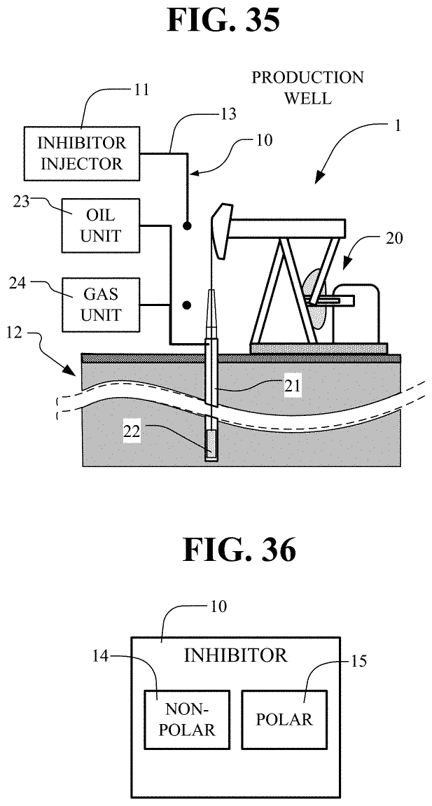

In FIG. 34, another example of the operation of the system of FIG. 34 is represented where all ten of the furnaces 6₁, 6₂, 6₃, 6₄, 6₅, 6₆, 6₇, 6₈, 6₉ and 6₁₀ are operating. In FIG. 35, graphs of the temperatures of ten furnaces 6 of FIG. 33 are shown. The furnaces are connected to the vapor unit 4-1 and 4-2 of FIG. 33. The LOAD, INCREASE, STEADY, DECREASE and UNLOAD steps for the ten furnaces 6₁, 6₂, 6₃, 6₄, 6₅, 6₆, 6₇, 6₈, 6₉ and 6₁₀ are listed in TABLE 2.

TABLE 2

| | LOAD | INCREASE | STEADY | DECREASE | UNLOAD |
|---|---|---|---|---|---|
| 6₁ | t0-t2 | t2-t5 | t5-t8 | t8-t11 | t11-t13 |
| 6₂ | t2-t4 | t4-t7 | t7-t10 | t10-t13 | t13-t15 |
| 6₃ | t4-t6 | t6-t9 | t9-t12 | t12-t15 | t15-t17 |
| 6₄ | t6-t8 | t8-t11 | t11-t14 | t14-t17 | t17-t19 |
| 6₅ | t8-t10 | t10-t13 | t13-t16 | t16-t19 | t19-t21 |
| 6₆ | t10-t12 | t12-t15 | t15-t18 | t18-t21 | t21-t23 |
| 6₇ | t12-t14 | t14-t17 | t17-t20 | t20-t23 | t23-t25 |
| 6₈ | t14-t16 | t16-t19 | t19-t22 | t22-t1* | t1-t3* |
| 6₉ | t16-t18 | t18-t21 | t21-t24 | t24-t3* | t3*-t5* |
| 6₁₀ | t18-t20 | t20-t23 | t23-t2* | t2*-t5* | t5*-t7* |

As is evident from TABLE 2, the offset of the processing for each of the furnaces 6₁, 6₂, 6₃, 6₄, 6₅, 6₆, 6₇, 6₈, 6₉ and 6₁₀ distributes the use of the system facilities so that no facility presents a bottleneck for processing. For example, each of the furnaces 6 is allocated a different time for the LOAD step so that loading is evenly distributed at the load station 7. Similarly, each of the furnaces 6 is allocated a different time for the UNLOAD step so that unloading is evenly distributed at the unload station 9. The pyrolysis processing times for the INCREASE, STEADY and DECREASE steps balance the load on the vapor unit 4-1 and vapor unit 4-2.

In FIG. 35, enhanced oil recovery (EOR) is done in an oil field 12. In oil fields like the oil field 12, as a result of the lowering of temperature of the oil as well pressures are reduced, deposit and crystallization of paraffin occurs causing the clogging of down-well pump parts and the spaces in the oil-bearing strata so that entrapped ground oil frequently cannot be efficiently recovered. Such conditions often results after primary and secondary recovery has occurred in the oil field. The oil field 12 includes a production well 1 including piping 21 extending down into the oil field 12. An inhibitor injector 11 connects to and supplies an injection stream in piping 13 to transport an inhibitor down the core 21. The injection stream in piping 13 is forced down the core 21 under substantial pressure from the inhibitor injector 11.

In FIG. 35, the production well 1 includes a pump 20 connected through the well core 21 to the down-hole pump 22. Oil and gas is pumped from the down-hole pump 22 through the well core 21 for processing and storage in the oil unit 23 and the gas unit 24. An inhibitor injector 11 injects, through piping 13, an inhibitor 10 into the production well 11 or into the oil unit 23 or gas unit 24. The inhibitor increases the flow of ground oil from the strata and through all extraction system components by dissolving, solubilizing or fragmenting paraffin and asphaltenes deposits to help withdraw the oil from the ground and improve the flow of the oil throughout the extraction system components. Also, the inhibitors in some embodiments are heated to make them more effective.

In FIG. 35, the inhibitor 10 is applied in different manners. In general, the inhibitor 10 is applied to pipe 13. The inhibitor 10 is applied by direct injection whereby the inhibitor 10 is left in the well 1. In some embodiments, the inhibitor 10 is passed through and removed ‘like flushing’ along with other injection methods. The cleaning process using the inhibitor 10 includes injecting the inhibitor 10 as part of a maintenance process. For example, during the operation of the well 1, one to five gallons are injected on a regular schedule that typically is daily or every two/three days to maintain a cleaner ‘ongoing’ well free of paraffin and asphaltenes. The injection of an inhibitor is typically also done into storage tanks, piping systems and pumps. Not only are the wells cleaned using the inhibitor, but the pipes and other support equipment and systems are also cleaned.

In FIG. 36, a block representation of typical non-polar components 14 and polar components 15 of the inhibitor 10 are shown for one example of pyrolysis processing. The total non-polar solvents in the one example are 5.33% in accordance with laboratory gas chromatography-mass spectrometry (GC-MS) testing. The effect of the non-polar components in the inhibitor 10 is potent. The approximately 5% of non-polar components in an inhibitor 10 operate for paraffin and asphaltenes control. Other major constituent components in the inhibitor 10 are polar substances that don't provide a direct contribution towards paraffin and asphaltenes control. However, the polar components play an important role as carriers for dispersing the non-polar components. The percentages of non-polar and polar components, and the actual components themselves, in the inhibitor 10 varies as a function of the chemical constituency of the tires or other organic material introduced into the furnace for pyrolysis processing. Typically, for conventional tires, the typical range of non-polar components is from 4% to 7% but other ranges are possible.

While the invention has been particularly shown and described with reference to preferred embodiments thereof it will be understood by those skilled in the art that various changes in form and details may be made therein without departing from the scope of the invention.

1. A pyrolysis system comprising:
one or more furnaces, each furnace including,
a chamber for receiving a cart supporting waste material for pyrolysis processing to form pyrolysis products,
a door in the furnace for opening to load and unload the cart and for closing to seal the chamber during pyrolysis processing,
a furnace port for receiving pyro-vapors from the chamber during pyrolysis processing,
one or more heat units, each heat unit for heating the chamber to pyrolysis temperatures,
a vapor unit for receiving pyro-vapors from the chamber during pyrolysis processing,
a control unit for controlling the pyrolysis processing with a heating cycle up to a temperature greater than 400° C. for greater than one hour.

2. The system of claim 1 wherein a nitrogen port is provided in each of the one or more furnaces for injecting nitrogen into the chamber for purging the chamber through the furnace port.

3. The system of claim 1 further including an unload station in a separate location from the furnace for removing pyro-solids from the cart.

4. The system of claim 3 wherein the unload station includes a magnetic separator for extracting steel from the pyro-solids.

5. The system of claim 1 wherein the vapor unit includes,
condenser stages for cooling pyro-vapors to separate out pyro-liquids,
a pyro-gas scrubber connected for processing uncondensed pyro-gases from the condenser stages to provide gas products.

6. The system of claim 5 wherein the scrubber removes sulfur and other impurities from the pyro-gas.

7. The system of claim 5 wherein the condenser stages operate over different temperature ranges to fractionally condense pyro-oils of different molecular weights and wherein the system further includes a pyro-oil unit for processing the pyro-oils of different molecular weights to form pyro-oil products including inhibitors.

8. The system of claim 1 including a control unit for controlling the furnaces over pyrolysis cycles, each pyrolysis cycle including a load step, a purge step, a temperature increase step, a temperature steady step, a temperature decrease step and an unload step.

9. The system of claim 8 wherein transportable carts during the load step of one pyrolysis cycle are made ready to be transported to a furnace where another transportable cart has been removed for the unload step of another pyrolysis cycle.

10. The system of claim 8 wherein for the pyrolysis cycles, the temperature increase step, the temperature steady step and the temperature decrease step are each about 3 hours long.

11. The system of claim 8 wherein outside gas is injected into the furnace chamber during the decrease step to accelerate cooling of the furnace chamber.

12. The system of claim 8 wherein the pyrolysis cycles for furnaces are offset in time whereby the pyrolysis system operates in a continuous mode.

13. The system of claim 12 wherein the pyrolysis cycles for eight furnaces operating on 12 hour cycle times are offset in time by approximately 2 hours.

14. The system of claim 8 wherein the temperature steady step is at approximately 1800° F. whereby the pyro-solids produced include pyro-carbon substantially free of pyro-oil.

15. The system of claim 1 wherein the system includes an N₂ source for supplying N₂ gas through a nitrogen port to purge the sealed furnace chamber of oxygen whereby the pyro-solids produced during the pyrolysis cycles include pyro-carbon which is not oxidized and is substantially reduced in ash content.

16. The system of claim 1 wherein a plurality of the furnaces have substantially the same design to facilitate manufacturing, maintenance and repairs in the system.

17. The system of claim 1 wherein a control unit turns off one or more of the furnaces while continuing operations with other furnaces whereby pyrolysis processing for the system continues with one or more of the furnaces off.

18. The system of claim 1 wherein a control unit matches the processing capabilities of furnaces and retorts to the waste material supply.

19. The system of claim 1 wherein a control unit sets pyrolysis operational parameters for a plurality of furnances where the pyrolysis operational parameters for some furnaces are different from the pyrolysis operational parameters for other furnaces.

20. The system of claim 1 wherein the waste material includes large tires having steel bands removed by bagel cutting prior to cutting the tires into pieces.

21. The system of claim 1 further including one or more fans for circulating gases within the furnace chamber for even heat distribution and to accelerate cooling.

22. A pyrolysis system comprising:
a load station for loading waste tire material into a plurality of carts,
a plurality of pyrolysis stations, each station including,
a pyrolysis furnace including,
a furnace chamber for receiving the plurality of carts, one at a time, with waste tire material for pyrolysis processing,
a furnace door opening for transporting the one of the carts into the chamber and for removing the one of the carts from the chamber, the furnace door for closing to seal the chamber for pyrolysis processing,
an exhaust port for exhausting pyro-vapors from the furnace chamber,
a nitrogen port for injecting nitrogen into the furnace chamber when the chamber is sealed to purge oxygen from the chamber through the exhaust port,
a heat unit for heating the furnace chamber to pyrolysis temperatures causing pyro-vapors to be generated from the waste tire material,
a vapor unit for receiving and processing the pyro-vapors from the exhaust port during pyrolysis processing,
an oil unit for receiving pyro-oil from the vapor unit,
an unload station for receiving the one of the carts with pyro-solids from the furnace chamber after pyrolysis processing and for unloading the pyro-solids.

23. A pyrolysis system comprising:
a load station for loading tire waste material into one or more carts,
a plurality of pyrolysis stations, each station including,
a pyrolysis furnace including,
a furnace wall surrounding a chamber for receiving the one or more carts, one at a time, with waste tire material for pyrolysis processing of the waste tire material,
a furnace door opening the furnace wall for transporting the one of the carts into the chamber and for removing the one of the carts from the chamber, the furnace door closing to seal the chamber for pyrolysis processing,
a nitrogen port for injecting nitrogen into the furnace chamber when the chamber is sealed to purge the chamber through the exhaust port,
an exhaust port for exhausting pyro-vapors from the furnace chamber,
a heat unit for heating the furnace chamber to the pyrolysis temperatures,
a fan unit including a motor external to the furnace wall, a shaft extending from the motor through the furnace wall and a fan blade connected to the shaft where the motor drives the fan blade to circulate gases within the chamber,
a vapor unit for receiving and processing the pyro-vapors from the exhaust port,
an oil unit for receiving pyro-oil from the vapor unit,
an unload station for receiving the one of the carts with pyro-solids from the furnace chamber, after pyrolysis processing, for unloading pyro-solids.

24. The pyrolysis system of claim 23 wherein,
the nitrogen injected by the nitrogen port causes air including oxygen to be exhausted through the exhaust port whereby the chamber is substantially oxygen free.

25. The pyrolysis system of claim 23 where the pyro-oil includes an inhibitor.
